(19) United States
(12) Patent Application Publication
(10) Pub. No.: US 2026/0306975 A1
(43) Pub. Date: Oct. 8, 2026

(54) Filter Assembly having a Locking Mechanism with Enhanced Engagement Features

(71) Applicant: Parker-Hannifin Corporation, Cleveland, OH (US)

(72) Inventors: Julian D. Voss, Vicksburg, MI (US); David J. Bouman, Kalamazoo, MI (US); Keith B. Waters, Plainwell, MI (US); Diego A. Camiro, Kalamazoo, MI (US)

(21) Appl. No.: 19/481,624

(22) PCT Filed: Feb. 6, 2024
(86) PCT No.: PCT/US2024/014554

§ 371 Date: Nov. 5, 2025

Related U.S. Application Data
(60) Provisional application No. 63/501,704, filed on May 12, 2023.

(51) Int. Cl. B01D 35/30; B01D 29/96; B01D 35/153

(52) U.S. Cl. CPC B01D 35/30; B01D 29/96; B01D 35/153; B01D 2201/4076

(57) ABSTRACT

An example filter assembly includes: a manifold comprising a housing having threads; a filter bowl comprising (i) respective threads configured to engage with the threads of the housing as the filter bowl is screwed into the housing, (ii) a ramped surface, and (iii) a notch; and a locking mechanism comprising a pawl, wherein as the filter bowl is screwed into the housing, the pawl traces the ramped surface, and wherein the pawl engages the notch after the pawl has moved past the ramped surface to lock the filter bowl to the manifold.

### CROSS REFERENCE TO RELATED APPLICATION

The present application claims priority to U.S. Provisional Patent Application No. 63/501,704, filed on May 12, 2023, the entire contents of which are herein incorporated by reference as if fully set forth in this description.

### BACKGROUND

Filters are used in hydraulic systems to remove impurities from a fluid. A typical filter assembly can include a filter bowl, which houses a filter element. The filter bowl attaches to a filter head, which can include an inlet and an outlet to facilitate flow of fluid into and out of the filter assembly. Because filter elements are routinely changed during maintenance, it is typical for the bowl to be hand-torqued during installation, which allows manual removal later. The lack of controlled installation torque may require judgment by the installer to determine when the bowl is satisfactorily engaged, and may also require a method of retaining the filter bowl to resist backing out due to vibration or hydraulic loads.

Conventional filters may have a locking mechanism to couple the filter bowl to the filter head. Such conventional filters, however, allow for engagement of the locking mechanism prior to full engagement of filter bowl to the filter head. This can cause a user to assume that full engagement has been achieved (e.g., based on visual and/or tactile feedback) before full engagement actually occurs. Partial engagement may diminish performance of the filter, cause leakage, lead to higher stresses, and lead to failure.

It may thus be desirable to have a filter assembly that ensures substantially-full engagement between the filter bowl and the filter head. It is with respect to these and other considerations that the disclosure made herein is presented.

### SUMMARY

The present disclosure describes implementations that relate to a filter assembly having a locking mechanism with enhanced engagement features.

In a first example implementation, the present disclosure describes a filter assembly including a manifold comprising a housing having threads; a filter bowl comprising (i) respective threads configured to engage with the threads of the housing as the filter bowl is screwed into the housing, (ii) a ramped surface, and (iii) a notch; and a locking mechanism comprising a pawl, wherein as the filter bowl is screwed into the housing, the pawl traces the ramped surface, and wherein the pawl engages the notch after the pawl has moved past the ramped surface to lock the filter bowl to the manifold.

In a second example implementation, the present disclosure describes a method of forming a filter assembly. The method includes: aligning a filter bowl with a housing of a manifold, wherein the housing comprises threads, and wherein the filter bowl comprises respective threads and a notch; screwing the filter bowl into the housing by engaging the respective threads of the filter bowl with the threads of the housing; delaying engagement of a pawl of a locking mechanism with the notch until the respective threads of the filter bowl has achieved substantially-full thread engagement with the threads of the housing; and engaging the pawl with the notch to lock the filter bowl in position and prevent the filter bowl from being unthreaded.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 illustrates a cross-sectional view of a manifold when a filter bowl and filter element are not installed, and fluid loss is prevented by a shut off valve, in accordance with an example implementation.

FIG. 2 illustrates a partial cross-sectional elevational view of a filter assembly in a partially-installed state where the shut off valve is preventing fluid flow therethrough, in accordance with an example implementation.

FIG. 3 illustrates a perspective exploded view of a locking mechanism, in accordance with an example implementation.

FIG. 4A illustrates a partial close-up cross-sectional front view of the filter assembly of FIG. 1 depicting initial contact of a ramped surface of the filter bowl with a lever of the locking mechanism of FIG. 3, in accordance with an example implementation.

FIG. 4B illustrates a partial close-up front view of the filter assembly of FIG. 1 depicting the initial contact of FIG. 4A, in accordance with an example implementation FIG. 5A illustrates a partial close-up front view of the filter assembly of FIG. 1 depicting a filter bowl in a first intermediate position, in accordance with an example implementation.

FIG. 5B illustrates a partial close-up front view of the filter assembly of FIG. 1 depicting a filter bowl in a second intermediate position, in accordance with an example implementation, in accordance with an example implementation.

FIG. 6A illustrates a partial close-up front view of the filter assembly of FIG. 1 depicting a pawl of a lever engaging a ratchet after traversing a ramped surface, in accordance with an example implementation.

FIG. 6B illustrates a partial close-up bottom view of the filter assembly of FIG. 1 depicting the pawl engaging the ratchet after traversing the ramped surface, in accordance with an example implementation,

FIG. 7 illustrates a partial cross-sectional elevational view of the filter assembly of FIG. 1 in an open position permitting fluid flow therethrough, in accordance with an example implementation.

FIG. 8 is a flowchart of a method of forming a filter assembly, in accordance with an example implementation.

### DETAILED DESCRIPTION

Disclosed herein are assemblies and methods associated with a filter assembly with features that assures substantially-full engagement of a filter bowl with a manifold (filter head) of the filter assembly prior to locking the filter bowl to the manifold. Within examples, the filter assemblies disclosed herein include a ratcheting and retention mechanism, which does not engage the filter bowl (e.g., the rotating element) until substantially-full engagement between the filter bowl and the manifold has been achieved.

In examples, the mechanism involves a ring having a ramp that a lever of a locking mechanism slides against. Full traversal of the lever across the ramp corresponds to substantially-full engagement of the filter bowl with the manifold, e.g., when the filter assembly is structurally and functionally ready for use. The lever is allowed to engage with a notch (e.g., space between teeth of a ratchet wheel) to lock the filter bowl to the manifold after the lever has traversed the ring. In other words, the lever may be blocked from accessing the notch until the filter bowl has substantially-fully engaged the manifold. This way, the locking mechanism cannot be engaged prematurely (e.g., prior to substantially-full engagement of the filter assembly with the manifold).

The disclosed systems, assemblies, and methods involve a filter assembly for fluids in a hydraulic system of a machine (e.g., an aircraft or a mobile machine such as an excavator, a wheel loader, a backhoe, an agricultural machine, etc.). The term “fluid” is used herein as including any liquid such as hydraulic fluid or lubrication oil that requires filtration, as examples.

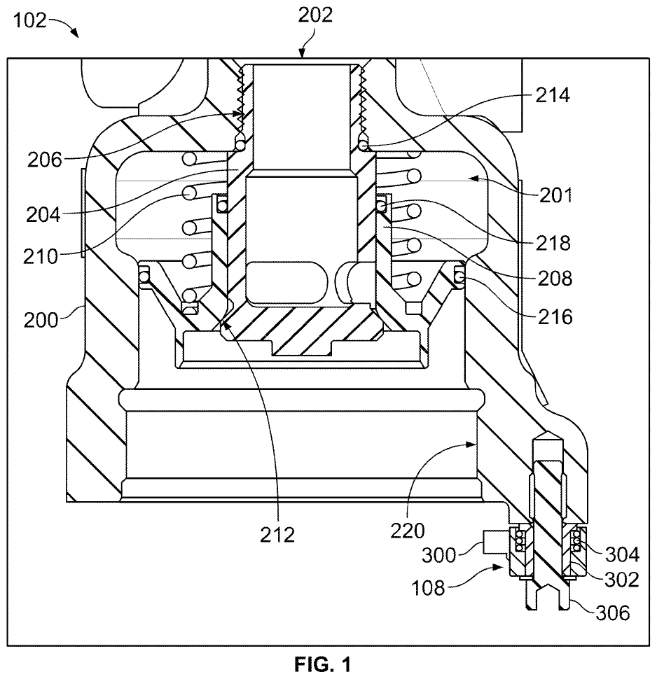

FIG. 1 illustrates a cross-sectional view of a manifold when a filter bowl and filter element are not installed, and fluid loss is prevented by a shut off valve, in accordance with an example implementation. The manifold 102 can also be referred to as a filter head, and is a subassembly of a filter assembly described below.

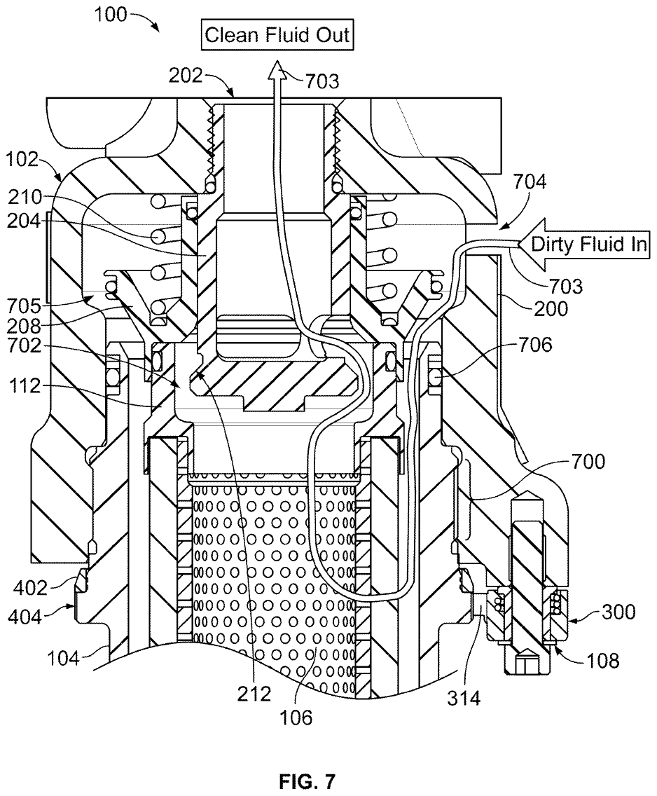

The manifold 102 includes a housing 200 that can be generally cylindrical with a cavity 201 therein. The housing 200 includes an inlet port (e.g., inlet port 704 shown in FIG. 7 described below) and an outlet port 202.

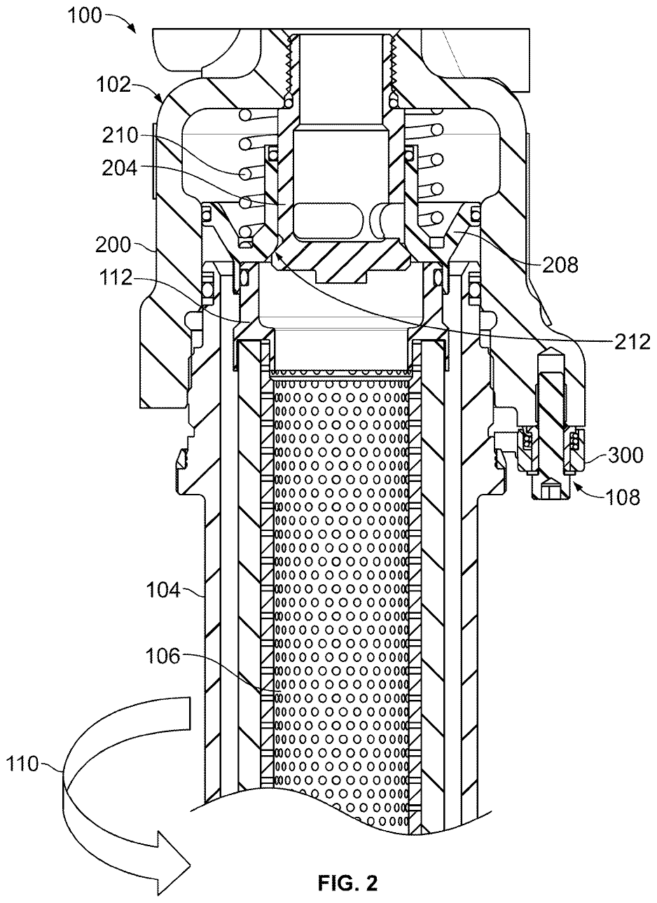

The manifold 102 also includes a spool guide 204 that is threaded into the housing 200 via threads 206. Thus, the spool guide 204 is fixedly coupled to the housing 200. The spool guide 204 is hollow as depicted in FIG. 2 to allow fluid flow therethrough to the outlet port 202.

The spool guide 204 operates as a linear guide for a spool 208 that is slidably accommodated about an exterior surface of the spool guide 204. As described below, the spool 208 is movable linearly (e.g., upward in FIG. 2) when the filter bowl 104 and/or filter element 106 are installed into the manifold 102.

The manifold 102 includes a biasing element such as a spring 210 disposed about an exterior surface of the spool 208. The spring 210 has a first end (e.g., upper end in FIG. 2) resting against an interior surface of the housing 200, and has a second end (e.g., lower end in FIG. 2) resting on the spool 208, thereby biasing the spool 208 to be seated at a seat 212 formed by the spool guide 204.

The manifold 102 includes several seals that prevent internal leakage or leakage to an external environment of the filter assembly 100. For example, the manifold 102 may include (i) a guide seal 214 that seals between the spool guide 204 and the housing 200, (ii) an exterior spool seal 216 disposed in an external groove in the spool 208 and configured to seal between the spool 208 and the interior surface of the housing 200, and (iii) an interior spool seal 218 configured to seal between the spool 208 and the spool guide 204.

FIG. 2 illustrates a partial cross-sectional elevational view of a filter assembly 100 in a partially-installed state where the shut off valve is preventing fluid flow therethrough, in accordance with an example implementation. The filter assembly 100 includes the manifold 102, which directs fluid flow through the filter assembly 100.

The filter assembly 100 includes a filter bowl 104 configured to engage the manifold 102 to form the filter assembly 100. The filter bowl 104 houses a filter element 106, which can have filter media configured to remove impurities from the fluid.

The filter assembly 100 further includes a locking mechanism 108, which is integrated into the manifold 102, and is configured to secure the manifold 102 to the filter bowl 104. Additionally, the locking mechanism 108 is configured to assure substantially-full or functional engagement of the filter bowl 104 with the manifold 102 prior to engagement of locking features, thereby avoiding any premature engagement of the locking features prior to substantial engagement of the filter bowl 104 with the manifold 102. FIG. 2 depicts a partially-installed or partially-assembled state of the filter assembly 100 where the filter bowl 104 has not yet been locked to the manifold 102 via the locking mechanism 108.

When the filter bowl 104 with filter element 106 are not fully installed as shown in FIG. 2 or are removed, the spring 210 pushes the spool 208 into the seat 212 to prevent fluid loss externally out of the spool guide 204. At the same time, the exterior spool seal 216, disposed in an external groove in the spool 208, engages the interior surface of the housing 200, preventing fluid loss externally past the spool 208. As such, the manifold 102 is configured with an automatic shut-off valve functionality that prevents external leakage once the filter bowl 104 and filter element 106 are removed. When the filter bowl 104 containing the filter element 106 is further installed from the state shown in FIG. 2 into the manifold 102, the filter element 106 biases the spool 208 against the spring 210, thereby unseating the spool 208 off the seat 212 and lifting the exterior spool seal 216 out of its sealing surface, allowing fluid flow from the inlet port through the filter element 106, then the spool guide 204 to the outlet port 202.

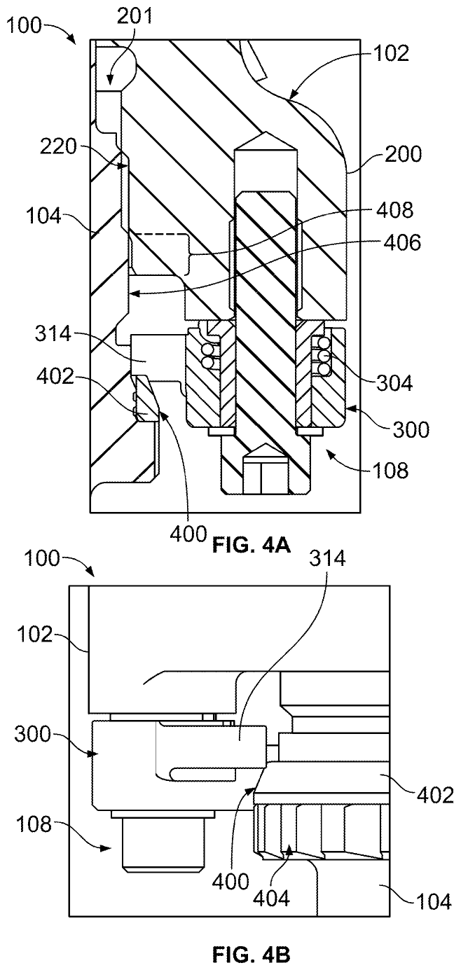

As shown in FIG. 1, the housing 200 of the manifold 102 includes internal threads 220 formed on an interior peripheral surface thereof. The internal threads 220 are configured to engage external threads (e.g., external threads 406 shown in FIG. 4A) formed on an exterior peripheral surface of the filter bowl 104 to couple the filter bowl 104 to the manifold 102. The locking mechanism 108 is configured to lock the filter bowl 104 in position once the external threads of the filter bowl 104 have substantially engaged the internal threads 220 of the housing 200.

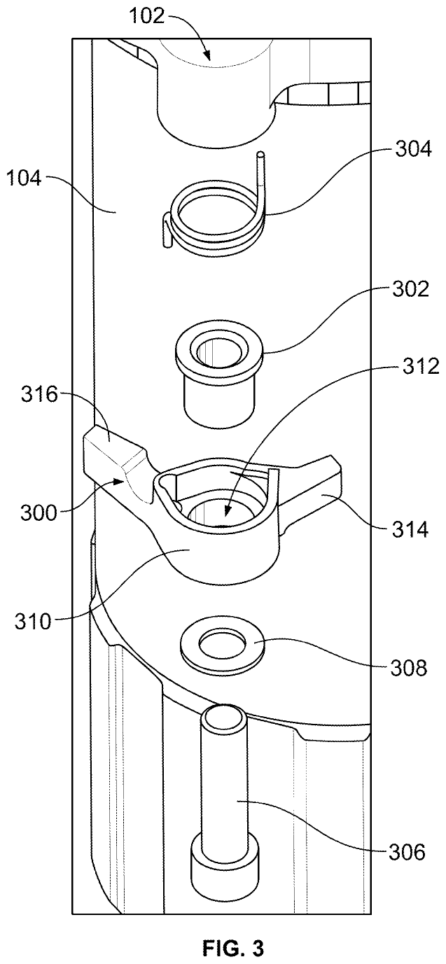

FIG. 3 illustrates a perspective exploded view of the locking mechanism 108, in accordance with an example implementation. In the example implementation of FIG. 3, the locking mechanism 108 includes a lever 300, a bushing 302, a torsional spring 304, a fastener 306 (e.g., bolt), and a washer 308. The fastener 306 and the washer 308 are configured to secure the lever 300, the bushing 302, and the torsional spring 304 to the housing 200 of the manifold 102 (see FIG. 2).

As shown in FIG. 3, in an example implementation, the lever 300 has a central cylindrical portion 310 having a hole 312 that accommodates the bushing 302 and the torsional spring 304. The torsional spring 304 is configured to be disposed about the bushing 302 (radially interposed between the exterior surface of the bushing 302 and the interior surface of the central cylindrical portion 310 of the lever 300). The lever 300 has a pawl 314 and an input arm 316 emanating from the central cylindrical portion 310.

A pawl is used herein to indicate a movable lever or arm that is spring loaded (e.g., via the torsional spring 304) configured to engage a fixed component (e.g., a ratchet, gear, or wheel) to prevent or restrain movement of such component in one direction. As such, it is a type of latch having a spring-loaded lever that engages a mating component at an angle to restrain such component.

As described in more detail below, the pawl 314 is configured to engage with a notch (e.g., space between teeth of a toothed wheel or ratchet) disposed about the filter bowl 104 to lock the filter bowl 104 in position. The torsional spring 304 (which can also be referred to as a torque spring or a spiral spring) engages interior surfaces of the lever 300 to bias the pawl 314 to remain engaged with such notch. The input arm 316 is configured to disengage the locking mechanism 108 to allow the filter bowl 104 to be removed from the manifold 102.

Referring back to FIG. 1, to install or mount the filter bowl 104 with the filter element 106 therein to the manifold 102, the filter bowl 104 can be aligned with the manifold 102, and the filter bowl 104 can then begin threaded engagement with the manifold 102 by twisting the filter bowl 104 in the direction indicated by arrow 110. The filter bowl 104 thus makes initial contact with the locking mechanism 108, and particularly with the lever 300, which is biased against the filter bowl 104 by the torsional spring 304. This state depicted in FIG. 1 can be referred to as initial engagement state. In this initial engagement state, a filter element cap 112 mounted to the filter element 106 contacts the spool 208.

FIG. 4A illustrates a partial close-up cross-sectional front view of the filter assembly 100 depicting initial contact of a ramped surface of the filter bowl 104 with the lever 300 of the locking mechanism 108, and FIG. 4B illustrates a partial close-up front view of the filter assembly 100 depicting the initial contact of FIG. 4A, in accordance with an example implementation. In FIG. 4B, the view of the filter assembly 100 is rotated 180° relative to the respective view of FIG. 4A.

As shown in FIGS. 4A-4B, the filter assembly 100, and particularly the filter bowl 104, can have a ramped surface 400 (which can also be referred to as a conical surface or tapered surface). In one example, the filter bowl 104 can have a ring 402 mounted about its exterior surface, and the ring 402 has the ramped surface 400 and a constant diameter portion following the ramped surface 400. However, in other examples, the ring 402 can be integral with the filter bowl 104, and the ramped surface 400 can thus be a portion of an exterior surface of the filter bowl 104.

Further, the filter bowl 104 can have one or more notches configured to interact with the pawl 314 of the lever 300 to lock the filter bowl 104 in position after threading the filter bowl 104 substantially fully into the manifold 102. For example, the filter bowl 104 can have a ratchet 404 (also referred to as a ratchet wheel) mounted adjacent (e.g., beneath) the ring 402. The ratchet 404 can have notches or teeth on its exterior surface configured to interact with the pawl 314 after the pawl 314 has traversed the ring 402 and the filter bowl 104 has been threaded to a particular extent into the housing 200 of the manifold 102.

As shown in FIG. 4A, for initial engagement of the filter bowl 104 with the manifold 102, the filter bowl 104 can be aligned with the cavity 201 within the manifold 102, and then external threads 406 of the filter bowl 104 can be engaged partially with the internal threads 220 of the housing 200 of the manifold 102. Partial engagement of the threads is indicated by an initial or first depth 408 of engagement. The filter bowl 104 can be a rotated one or more rotations to achieve an initial threaded engagement with the housing 200 until the ring 402 contacts the pawl 314 as shown in the position or state shown in FIGS. 4A-4B.

Further threading (rotation) of the filter bowl 104 into the housing 200 causes the pawl 314 to traverse the ramped surface 400 of the ring 402. Particularly, as the filter bowl 104 is threaded further into the housing 200 (e.g., the filter bowl 104 moves upward), the inclination of the ramped surface 400 pushes the pawl 314 outward, but the torsional spring 304 forces the pawl 314 against the ramped surface 400 to maintain contact between the pawl 314 and the ramped surface 400 and force the pawl 314 to trace the ramped surface 400. The pawl 314 thus continues to slide against the ramped surface 400 as the filter bowl 104 is further threaded into the housing 200.

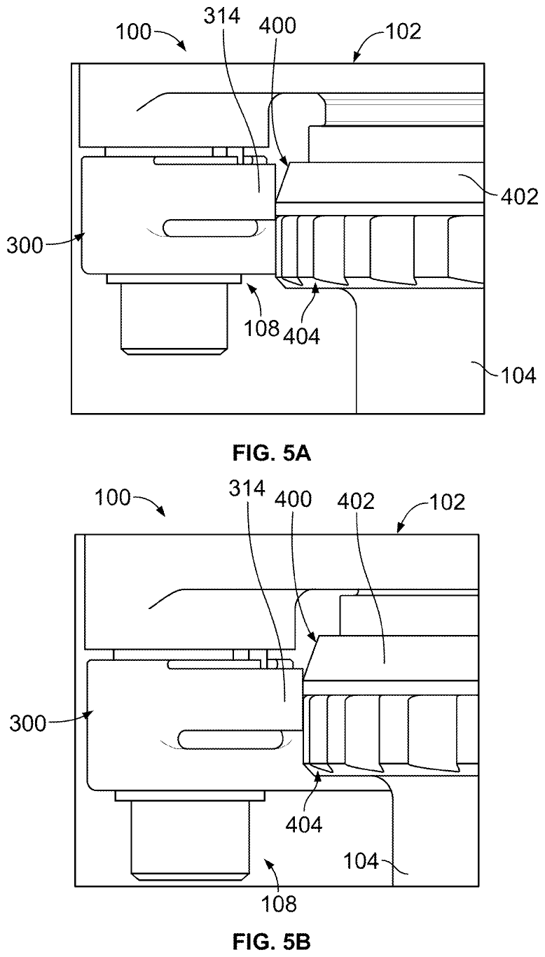

FIG. 5A illustrates a partial close-up front view of the filter assembly 100 depicting the filter bowl 104 in a first intermediate position, and FIG. 5B illustrates a partial close-up front view of the filter assembly 100 depicting the filter bowl 104 in a second intermediate position, in accordance with an example implementation. In both intermediate positions shown in FIG. 5A-5B, the pawl 314 has not yet cleared (i.e., moved past) the ring 402, and has thus not engaged the teeth of the ratchet 404.

Notably, as long as the pawl 314 has not engaged the ratchet 404, an operator assembling the filter assembly 100 has an indication that the filter bowl 104 is not yet properly mounted and threaded into the manifold 102. Only when the pawl 314 has fully traversed the ring 402, the pawl 314 can then engage the teeth of the ratchet 404 to lock the filter bowl 104 in position.

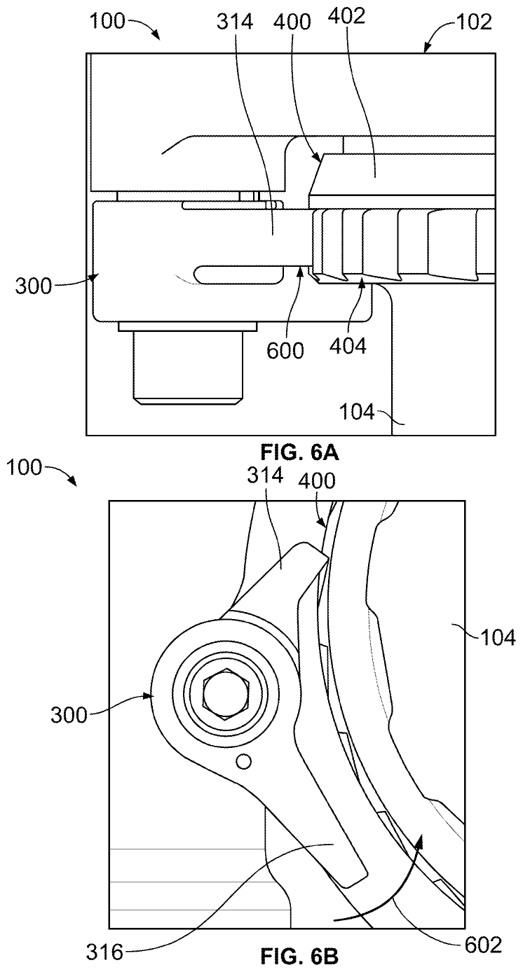

FIG. 6A illustrates a partial close-up front view of the filter assembly 100 depicting the pawl 314 of the lever 300 engaging the ratchet 404 after traversing the ring 402, and FIG. 6B illustrates a partial close-up bottom view of the filter assembly 100 depicting the pawl 314 engaging the ratchet 404 after traversing the ramped surface 400, in accordance with an example implementation. The filter bowl 104 continues to move as it is further threaded into the housing 200, until the pawl 314 “clears” (traverses and moves past) the ramped surface 400. After the pawl 314 moves past the ramped surface 400, the torsional spring 304 forces the pawl 314 of the lever 300 to “drop” into a notch 600 (e.g., space between two consecutive teeth) of the ratchet 404. The pawl 314 thus interacts with the ratchet 404 to prevent unthreading of the filter bowl 104 (e.g., preventing the filter bowl 104 from rotating in the opposite direction) and locks the filter bowl 104 in position. In this depiction, it may be possible to continue rotating the filter bowl 104 in the tightening direction indicated by the arrow 110 until the next tooth of the ratchet 404 is engaged; however functional or substantially-full engagement has been achieved after dropping into the first tooth.

FIG. 7 illustrates a partial cross-sectional elevational view of the filter assembly 100 in an open position permitting fluid flow therethrough, in accordance with an example implementation. As depicted in FIG. 7, the filter bowl 104 has been threaded into the housing 200 of the manifold 102 to the extent that the pawl 314 of the lever 300 has completely traced the ring 402, the ring 402 has moved past the lever 300, and the pawl 314 has engaged the ratchet 404.

At this position, a second depth 700 of threaded engagement is achieved between the external threads 406 of the filter bowl 104 (see FIG. 4A) and the internal threads 220 of the housing 200. As shown, the second depth 700 of threaded engagement represents substantially full engagement of the external threads 406 with the internal threads 220.

The term “thread engagement” is used here to indicate the amount of overlap between the internal threads 220 of the housing 200 and the external threads 406 of the filter bowl 104. Further, the term “substantially-full thread engagement” indicates a state where the external threads 406 of the filter bowl 104 are screwed in sufficiently deep into the internal threads 220 of the housing 200 to create a functional, structurally sound connection. The minimum number of threads is dependent on the application; however, a typical determining factor is the maximum “blow off” force generated by internal pressure acting on the filter bowl 104, which is resisted by the threads.

Thus, with the configuration described above, as the filter bowl 104 is screwed into the housing 200, the position of the ring 402 relative to the lever 300 is “timed” such that the pawl 314 does not engage the ratchet 404 until substantially-full thread engagement between the filter bowl 104 and the housing 200 has been achieved. In other words, the configuration involving the ring 402 with the ramped surface 400 delays the engagement of the pawl 314 with the ratchet 404 until substantially-full thread engagement between the filter bowl 104 and the housing 200 has been achieved.

Thus, the locking mechanism 108 (particularly the pawl 314) does not engage the filter bowl 104 until the filter bowl 104 is substantially-fully installed within the manifold 102. The ring 402 with the ramped surface 400 blocks access to the notches of the ratchet 404 until substantially-full thread engagement has been achieved between the filter bowl 104 and the manifold 102. In this manner, when an operator is installing the filter bowl 104, as the operator receives a visual, auditory, or tactile indication that the pawl 314 has engaged the ratchet 404, substantially-full thread engagement between the filter bowl 104 and the housing 200 has also been achieved.

Further, in the state shown in FIG. 7 associated with substantially-full thread engagement between the filter bowl 104 and the housing 200, the filter element cap 112 mounted to the filter element 106 has caused the spool 208 to be lifted off the seat 212 of the spool guide 204, thereby forming a flow area 702. Likewise, as the spool 208 is lifted, the exterior spool seal 216 is lifted out of the housing 200 bore, thereby forming a flow area 705. As such, as depicted in FIG. 7, fluid is allowed to flow (as indicated by flow arrow 703) through inlet port 704 formed in the manifold 102, then through flow area 705, then into the filter bowl 104, then through the filter element 106 (which removes impurities) then through the flow area 702, through the spool guide 204, and is discharged through the outlet port 202.

Notably, when substantially-full thread engagement between the filter bowl 104 and the housing 200 has been achieved, the flow areas 702, 705 are configured to be sufficiently large to reduce pressure drop across the filter assembly 100. In conventional systems where it is possible to have smaller thread engagement, either when the locking mechanism first engages or when the operator believes the filter bowl is properly installed, the flow area can be reduced, thereby increasing the pressure drop across the filter assembly 100.

The filter element 106 is a replaceable filter element that might be replaced periodically. As such, referring back to FIG. 6B, the input arm 316 can be rotated manually or by other means in a given direction (e.g., counter-clockwise in a direction of an arrow 602) to disengage the pawl 314 of the lever 300 from the ratchet 404. This way, the filter bowl 104 can be unthreaded, and the filter element 106 can be replaced. The filter bowl 104 with the new filter element can then be mounted again to the manifold 102 as described above.

Thus, the filter assembly 100 may provide several advantages over existing filter systems. The above-described “timing” configuration that ensures engagement of the pawl 314 with the ratchet 404 to lock the filter bowl 104 in position only after substantially-full thread engagement between the filter bowl 104 and the housing 200 has been achieved, ensures proper retention of the filter bowl 104 to the housing 200. This configuration is much less prone to operator error in perceiving that a lock has been achieved at a smaller thread engagement depth.

This configuration also ensures repeatability every time the filter bowl 104 is removed and reinstalled. Every time the filter bowl 104 is removed, automatic shut-off is achieved, and when the filter bowl 104 is reinstalled, a maximum flow area (e.g., the flow areas 702, 705) is achieved, thereby ensuring a minimal pressure drop.

Further, referring to FIG. 7, the disclosed configuration ensures that a seal 706 disposed in a groove on the exterior surface of the filter bowl 104 and sealing against an interior surface of the housing 200 has a minimum amount of seal engagement when the pawl 314 engages the ratchet 404. This ensures that no external leakage occurs.

Thus, the disclosed configuration ensures proper function of the filter assembly 100 when the user receives visual, auditory, or tactile feedback that the pawl 314 has engaged the ratchet 404. It may thus eliminate any misinterpretation of when the filter bowl 104 has fully engaged the housing 200.

Several variations can be implemented to the filter assembly 100, while using the same principles described herein. For example, the configuration can be reversed such that the locking mechanism 108 can be mounted to the filter bowl 104, while the ring 402 with the ramped surface 400 can be comprised in the housing 200 of the manifold 102. Further, rather than aligning and rotating the filter bowl 104 relative to the housing 200, the manifold 102 can be the rotating element.

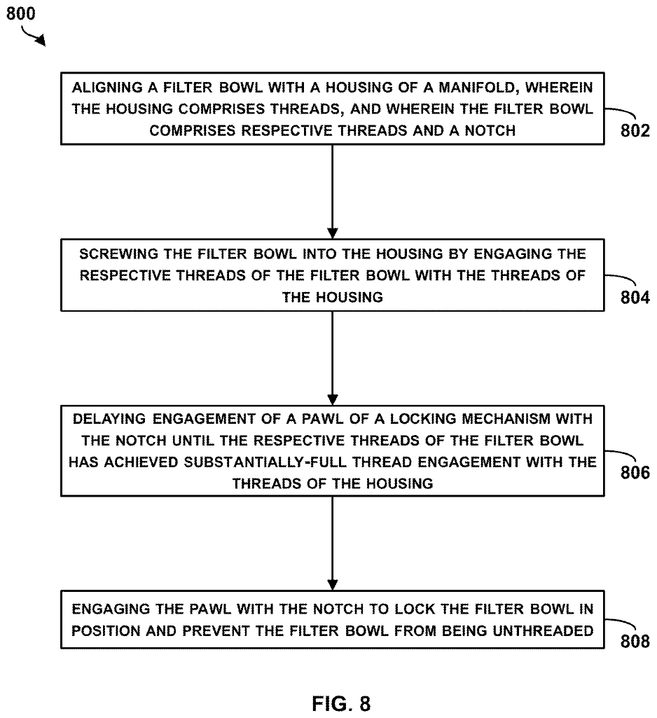

FIG. 8 is a flowchart of a method 800 of forming a filter assembly, in accordance with an example implementation. The method 800 may include one or more operations, functions, or actions as illustrated by one or more of steps 802-808.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 802, the method 800 includes aligning the filter bowl 104 with the housing 200 of the manifold 102, wherein the housing 200 comprises threads (e.g., the internal threads 220), and wherein the filter bowl 104 comprises respective threads (e.g., the external threads 406) and a notch (e.g., the notch 600 between teeth of the ratchet 404).

At block 804, the method 800 includes screwing the filter bowl 104 into the housing 200 by engaging the respective threads of the filter bowl 104 with the threads of the housing 200.

At block 806, the method 800 includes delaying engagement of the pawl 314 of the locking mechanism 108 with the notch until the respective threads of the filter bowl 104 has achieved substantially-full thread engagement with the threads of the housing 200. Such delay can be accomplished, for example, by having the pawl 314 trace the ring 402.

At block 808, the method 800 includes engaging the pawl 314 with the notch to lock the filter bowl 104 in position and prevent the filter bowl 104 from being unthreaded.

The method 800 can further include other steps to assemble the filter assembly 100 as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 a filter assembly comprising: a manifold comprising a housing having threads; a filter bowl comprising (i) respective threads configured to engage with the threads of the housing as the filter bowl is screwed into the housing, (ii) a ramped surface, and (iii) a notch; and a locking mechanism comprising a pawl, wherein as the filter bowl is screwed into the housing, the pawl traces the ramped surface, and wherein the pawl engages the notch after the pawl has moved past the ramped surface to lock the filter bowl to the manifold.

EEE 2 is the filter assembly of EEE 1, wherein the threads of the housing are internal threads formed on an interior peripheral surface of the housing, and wherein the respective threads of the filter bowl are external threads formed on an exterior peripheral surface of the filter bowl.

EEE 3 is the filter assembly of any of EEEs 1-2, wherein the locking mechanism is mounted to the housing of the manifold, and wherein the locking mechanism further comprises: a lever comprising the pawl; and a torsional spring mounted within the lever and configured to bias the pawl toward the ramped surface and the notch.

EEE 4 is the filter assembly of EEE 3, wherein the lever comprises a central cylindrical portion having a hole, and wherein the locking mechanism further comprises: a bushing mounted within the hole, wherein the torsional spring is disposed about the bushing, such that the torsional spring is radially interposed between an exterior surface of the bushing and an interior surface of the central cylindrical portion of the lever.

EEE 5 is the filter assembly of any of EEEs 3-4, wherein the lever further comprises an input arm configured to be rotated to disengage the pawl from the notch and allow the filter bowl to be unscrewed.

EEE 6 is the filter assembly of any of EEEs 1-5, further comprising: a ring mounted about the filter bowl, wherein the ring comprises the ramped surface.

EEE 7 is the filter assembly of any of EEEs 1-6, wherein when the pawl has moved past the ramped surface and engaged the notch, the respective threads of the filter bowl has achieved substantially-full thread engagement with the threads of the housing.

EEE 8 is the filter assembly of any of EEEs 1-7, wherein the filter bowl comprises a ratchet comprising the notch.

EEE 9 is the filter assembly of any of EEEs 1-8, wherein the manifold further comprises: an inlet port and an outlet port; a spool guide that is fixedly coupled to the housing; a spool that is slidably accommodated about an exterior surface of the spool guide; and a spring disposed about an exterior surface of the spool and configured to bias the spool to be seated at a seat formed by the spool guide, such that fluid flow from the inlet port to the outlet port is prevented prior to mounting the filter bowl to the housing.

EEE 10 is the filter assembly of EEE 9, further comprising: a filter element disposed within the filter bowl, wherein as the filter bowl is screwed into the housing, the filter element unseats the spool off the seat of the spool guide to allow fluid flow from the inlet port to the outlet port.

EEE 11 is the filter assembly of EEE 10, further comprising: a filter element cap mounted to the filter element and configured to contact and unseat the spool as the filter bowl is screwed into the housing.

EEE 12 a method comprising: aligning a filter bowl with a housing of a manifold, wherein the housing comprises threads, and wherein the filter bowl comprises respective threads and a notch; screwing the filter bowl into the housing by engaging the respective threads of the filter bowl with the threads of the housing; delaying engagement of a pawl of a locking mechanism with the notch until the respective threads of the filter bowl has achieved substantially-full thread engagement with the threads of the housing; and engaging the pawl with the notch to lock the filter bowl in position and prevent the filter bowl from being unthreaded.

EEE 13 is the method of EEE 12, wherein the filter bowl further comprises a ramped surface, and wherein delaying engagement of the pawl with the notch comprises: causing the pawl to trace the ramped surface as the respective threads of the filter bowl engage the threads of the housing, wherein the pawl engages the notch after the pawl has moved past the ramped surface.

EEE 14 is the method of EEE 13, wherein the locking mechanism is mounted to the housing of the manifold, wherein the locking mechanism further comprises: a lever comprising the pawl, and a torsional spring mounted within the lever, and wherein the method further comprises: biasing the pawl toward the ramped surface and the notch via the torsional spring.

EEE 15 is the method of EEE 14, wherein the lever further comprises an input arm, and wherein the method further comprises: rotating the input arm to disengage the pawl from the notch and allow the filter bowl to be unscrewed.

EEE 16 is the method of any of EEEs 14-15, wherein the filter bowl further comprises a ring having a ramped surface, and wherein delaying engagement of the pawl with the notch comprises: causing the pawl to trace the ramped surface of the ring as the respective threads of the filter bowl engage the threads of the housing, wherein the pawl engages the notch after the pawl has moved past the ramped surface of the ring.

EEE 17 is the method of any of EEEs 12-16, wherein the filter bowl comprises a ratchet comprising a plurality of teeth forming the notch, and wherein engaging the pawl with the notch to lock the filter bowl in position comprises: engaging the pawl with the ratchet.

EEE 18 is the method of any of EEEs 12-17, wherein the manifold further comprises: an inlet port and an outlet port, a spool guide that is fixedly coupled to the housing, a spool that is slidably accommodated about an exterior surface of the spool guide, and a spring disposed about an exterior surface of the spool, and wherein the method further comprises: biasing the spool to be seated at a seat formed by the spool guide to prevent fluid flow from the inlet port to the outlet port prior to mounting the filter bowl to the housing.

EEE 19 is the method of EEE 18, wherein the filter bowl comprises a filter element disposed therein, and wherein the method further comprises: as the filter bowl is screwed into the housing, causing the filter element to unseat the spool off the seat of the spool guide to allow fluid flow from the inlet port to the outlet port.

EEE 20 is the method of EEE 19, wherein the filter element has a filter element cap mounted thereon, and wherein causing the filter element to unseat the spool comprises: causing the filter element cap to contact and unseat the spool as the filter bowl is screwed into the housing.

What is claimed is:

1. A filter assembly comprising:
a manifold comprising a housing having threads;
a filter bowl comprising (i) respective threads configured to engage with the threads of the housing as the filter bowl is screwed into the housing, (ii) a ramped surface, and (iii) a notch; and
a locking mechanism comprising a pawl, wherein as the filter bowl is screwed into the housing, the pawl traces the ramped surface, and wherein the pawl engages the notch after the pawl has moved past the ramped surface to lock the filter bowl to the manifold.

2. The filter assembly of claim 1, wherein the threads of the housing are internal threads formed on an interior peripheral surface of the housing, and wherein the respective threads of the filter bowl are external threads formed on an exterior peripheral surface of the filter bowl.

3. The filter assembly of claim 1, wherein the locking mechanism is mounted to the housing of the manifold, and wherein the locking mechanism further comprises:
a lever comprising the pawl; and
a torsional spring mounted within the lever and configured to bias the pawl toward the ramped surface and the notch.

4. The filter assembly of claim 3, wherein the lever comprises a central cylindrical portion having a hole, and wherein the locking mechanism further comprises:
a bushing mounted within the hole, wherein the torsional spring is disposed about the bushing, such that the torsional spring is radially interposed between an exterior surface of the bushing and an interior surface of the central cylindrical portion of the lever.

5. The filter assembly of claim 3, wherein the lever further comprises an input arm configured to be rotated to disengage the pawl from the notch and allow the filter bowl to be unscrewed.

6. The filter assembly of claim 1, further comprising:
a ring mounted about the filter bowl, wherein the ring comprises the ramped surface.

7. The filter assembly of claim 1, wherein when the pawl has moved past the ramped surface and engaged the notch, the respective threads of the filter bowl has achieved substantially-full thread engagement with the threads of the housing.

8. The filter assembly of claim 1, wherein the filter bowl comprises a ratchet comprising the notch.

9. The filter assembly of claim 1, wherein the manifold further comprises:
an inlet port and an outlet port;
a spool guide that is fixedly coupled to the housing;
a spool that is slidably accommodated about an exterior surface of the spool guide; and
a spring disposed about an exterior surface of the spool and configured to bias the spool to be seated at a seat formed by the spool guide, such that fluid flow from the inlet port to the outlet port is prevented prior to mounting the filter bowl to the housing.

10. The filter assembly of claim 9, further comprising:
a filter element disposed within the filter bowl, wherein as the filter bowl is screwed into the housing, the filter element unseats the spool off the seat of the spool guide to allow fluid flow from the inlet port to the outlet port.

11. The filter assembly of claim 10, further comprising:
a filter element cap mounted to the filter element and configured to contact and unseat the spool as the filter bowl is screwed into the housing.

12. A method comprising:
aligning a filter bowl with a housing of a manifold, wherein the housing comprises threads, and wherein the filter bowl comprises respective threads and a notch;
screwing the filter bowl into the housing by engaging the respective threads of the filter bowl with the threads of the housing;
delaying engagement of a pawl of a locking mechanism with the notch until the respective threads of the filter bowl has achieved substantially-full thread engagement with the threads of the housing; and
engaging the pawl with the notch to lock the filter bowl in position and prevent the filter bowl from being unthreaded.

13. The method of claim 12, wherein the filter bowl further comprises a ramped surface, and wherein delaying engagement of the pawl with the notch comprises:
causing the pawl to trace the ramped surface as the respective threads of the filter bowl engage the threads of the housing, wherein the pawl engages the notch after the pawl has moved past the ramped surface.

14. The method of claim 13, wherein the locking mechanism is mounted to the housing of the manifold, wherein the locking mechanism further comprises: a lever comprising the pawl, and a torsional spring mounted within the lever, and wherein the method further comprises:
biasing the pawl toward the ramped surface and the notch via the torsional spring.

15. The method of claim 14, wherein the lever further comprises an input arm, and wherein the method further comprises:
rotating the input arm to disengage the pawl from the notch and allow the filter bowl to be unscrewed.

16. The method of claim 14, wherein the filter bowl further comprises a ring having a ramped surface, and wherein delaying engagement of the pawl with the notch comprises:
causing the pawl to trace the ramped surface of the ring as the respective threads of the filter bowl engage the threads of the housing, wherein the pawl engages the notch after the pawl has moved past the ramped surface of the ring.

17. The method of claim 12, wherein the filter bowl comprises a ratchet comprising a plurality of teeth forming the notch, and wherein engaging the pawl with the notch to lock the filter bowl in position comprises:
engaging the pawl with the ratchet.

18. The method of claim 12, wherein the manifold further comprises: an inlet port and an outlet port, a spool guide that is fixedly coupled to the housing, a spool that is slidably accommodated about an exterior surface of the spool guide, and a spring disposed about an exterior surface of the spool, and wherein the method further comprises:
biasing the spool to be seated at a seat formed by the spool guide to prevent fluid flow from the inlet port to the outlet port prior to mounting the filter bowl to the housing.

19. The method of claim 18, wherein the filter bowl comprises a filter element disposed therein, and wherein the method further comprises:
as the filter bowl is screwed into the housing, causing the filter element to unseat the spool off the seat of the spool guide to allow fluid flow from the inlet port to the outlet port.

20. The method of claim 19, wherein the filter element has a filter element cap mounted thereon, and wherein causing the filter element to unseat the spool comprises:
causing the filter element cap to contact and unseat the spool as the filter bowl is screwed into the housing.
